(19) United States
(12) Patent Application Publication
(10) Pub. No.: US 2025/0136774 A1
(43) Pub. Date: May 1, 2025

(54) HOT PRESSING MEMBRANE

(71) Applicant: DARFON ELECTRONICS CORP., TAOYUAN CITY (TW)

(72) Inventors: Li-Sheng TENG, TAOYUAN CITY (TW); Shih-Kai CHEN, TAOYUAN CITY (TW)

(21) Appl. No.: 18/826,560

(22) Filed: Sep. 6, 2024

(30) Foreign Application Priority Data
Oct. 31, 2023 (TW) 112141747

(51) Int. Cl. C08J 7/04; C08J 5/12; C08J 7/046

(52) U.S. Cl. CPC C08J 7/042; C08J 5/121; C08J 7/046; C08J 2323/06; C08J 2323/12; C08J 2367/06; C08J 2369/00; C08J 2375/04

(57) ABSTRACT

A hot pressing membrane includes a carrier film, a decorative layer formed on the carrier film, and a transparent protective layer formed on the decorative layer. The decorative layer includes, in parts by weight, 4.0 to 6.0 parts by weight of a first thermoplastic polyurethane, 1.0 to 2.0 parts by weight of a pigment, and 12.0 to 15.0 parts by weight of a first solvent. The transparent protective layer includes, in parts by weight, 4.0 to 6.0 parts by weight of a second thermoplastic polyurethane, 0.6 to 2.0 parts by weight of a functional additive, and 11.0 to 14.0 parts by weight of a second solvent. The hot pressing membrane of the invention is via the carrier film bonded to an outer surface of an object by a hot pressing process. The hot pressing membrane of the invention has a scratch resistance equal to or greater than 50 times.

### CROSS-REFERENCE TO RELATED APPLICATION

This utility application claims priority to Taiwan Application Serial Number 112141747, filed Oct. 31, 2023, which is incorporated herein by reference.

### BACKGROUND OF THE INVENTION

### 1. Field of the Invention

The invention relates to a hot pressing membrane, and in particular, to a hot pressing membrane which is abrasion-resistant and has high hydrophobicity, good tactile and the capability of serving as a linking device to link different objects.

### 2. Description of the Prior Art

A hot pressing membrane is bonded to an outer surface of an object to decorate the object by applying a hot pressing process.

With the development of hot pressing membranes, the hot pressing membranes have also been utilized as linking devices to link different objects. For example, hot press films are used by the hot pressing process to link objects such as switches, keyboards, and other devices or members that require pressing for operation.

However, there is still much room for improvement in terms of abrasion resistance, hydrophobicity, tactile and so on of hot pressing membranes, which are used as linking devices to link different objects. In particular, when the hot pressing membrane is linked by a hot pressing process to an object such as a switch, a keyboard, and other device or member of an apparatus that require pressing operation, the properties of the hot pressing membrane with respect to pressing should also be considered.

### SUMMARY OF THE INVENTION

Accordingly, one scope of the invention is to provide a hot pressing membrane which is abrasion-resistant and has high hydrophobicity, good tactile and the capability of serving as a linking device to link different objects.

A hot pressing membrane according to the first preferred embodiment of the invention is used to decorate a first outer surface of a first object. The hot pressing membrane according to the first preferred embodiment of the invention includes a carrier film, a decorative layer and a transparent protective layer. The carrier film can be formed of a polypropylene (PP), a polyethylene (PE), a polyethylene terephthalate (PET), a polycarbonate (PC) or the like. A first thickness of the carrier film ranges from 0.12 mm to 0.18 mm. The decorative layer is formed on the carrier film. The decorative layer includes, in parts by weight, 4.0 to 6.0 parts by weight of a first thermoplastic polyurethane (TPU), 1.0 to 2.0 parts by weight of a pigment, and 12.0 to 15.0 parts by weight of a first solvent. The first thermoplastic polyurethane, the pigment and the first solvent are mixed, coated on the carrier film, and baked and dried at a first baking temperature to form the decorative layer. The first baking temperature ranges from 50° C. to 100° C. A second thickness of the decorative layer ranges from 40 μm to 50 μm. The transparent protective layer is formed on the decorative layer. The transparent protective layer includes, in parts by weight, 4.0 to 6.0 parts by weight of a second thermoplastic polyurethane (TPU), 0.6 to 2.0 parts by weight of a functional additive, and 11.0 to 14.0 parts by weight of a second solvent. The functional additive can include a plurality of matting powders, an antimicrobial agent, an antistatic agent, and so on. The second thermoplastic polyurethane, the functional additive and the second solvent are mixed, coated on the decorative layer, and baked and dried at a second baking temperature to form the transparent protective layer. The second baking temperature ranges from 50° C. to 100° C. A third thickness of the transparent protective layer ranges from 50 μm to 60 μm. The hot pressing membrane according to the first preferred embodiment of the invention is via the carrier film bonded to the first outer surface of the first object by a hot pressing process. A mold temperature of the hot pressing process ranges from 80° C. to 130° C. The hot pressing membrane according to the first preferred embodiment of the invention has a scratch resistance equal to or greater than 50 times under a test load of 200 gf in accordance with the ASTM D3363 test standard. The Shore hardness of the hot pressing membrane according to the first preferred embodiment of the invention ranges from 70 A to 75 A.

In one embodiment, the functional additive is the plurality of matting powders. A contact angle of a water droplets on the hot pressing membrane according to the first preferred embodiment of the invention ranges from 80 degrees to 115 degrees.

In one embodiment, the first solvent cam be a first dimethylacetamide (DMAC), a first butyl acetate (BAC), a first ethylene glycol monoethyl ether acetate (CAC), or a mixture therebetween.

In one embodiment, the second solvent can be a second dimethylacetamide (DMAC), a second butyl acetate (BAC), a second ethylene glycol monoethyl ether acetate (CAC), or a mixture therebetween.

In one embodiment, during the hot pressing process, the hot pressing membrane according to the first preferred embodiment of the invention is also bonded to a second outer surface of a second object via the carrier film to link the first object and the second object. A gap exists between the first object and the second object. The second outer surface of the second object is pressed downward against the first object with a peak force in a first range of 50 g to 70 g and a click ratio in a second range of 35% to 55%.

A hot pressing membrane according to the second preferred embodiment of the invention is used to decorate a first outer surface of a first object. The hot pressing membrane according to the second preferred embodiment of the invention includes a carrier film, a transparent protective layer and a decorative layer. The carrier film can be formed of a polypropylene (PP), a polyethylene (PE), a polyethylene terephthalate (PET), a polycarbonate (PC), or the like. A first thickness of the carrier film ranging from 0.12 mm to 0.18 mm. The transparent protective layer is formed on the carrier film. The transparent protective layer includes, in parts by weight, 4.0 to 6.0 parts by weight of a first thermoplastic polyurethane, 0.6 to 2.0 parts by weight of a functional additive, and 11.0 to 14.0 parts by weight of a first solvent. The functional additive can include a plurality of matting powders, an antimicrobial agent, an antistatic agent, and so on. The first thermoplastic polyurethane, the functional additive and the first solvent are mixed, coated on the carrier film, and baked and dried at a first baking temperature to form the transparent protective layer. The first baking temperature ranges from 50° C. to 100° C. A second thickness of the transparent protective layer ranges from 50 μm to 60 μm. The decorative layer is formed on the transparent protective layer. The decorative layer includes, in parts by weight, 4.0 to 6.0 parts by weight of a second thermoplastic polyurethane (TPU), 1.0 to 2.0 parts by weight of a pigment, and 12.0 to 15.0 parts by weight of a second solvent. The second thermoplastic polyurethane, the pigment and the second solvent are mixed, coated on the transparent protective layer, and baked and dried at a second baking temperature to form the decorative layer. The second baking temperature ranges from 50° C. to 100° C. A third thickness of the decorative layer ranges from 40 μm to 50 μm. The hot pressing membrane according to the second preferred embodiment of the invention is via the decorative layer bonded to the first outer surface of the first object by a hot pressing process. A mold temperature of the hot pressing process ranges from 80° C. to 130° C. The hot pressing membrane according to the second preferred embodiment of the invention has a scratch resistance equal to or greater than 50 times under a test load of 200 gf in accordance with the ASTM D3363 test standard. The Shore hardness of the hot pressing membrane according to the second preferred embodiment of the invention ranges from 70 A to 75 A.

In one embodiment, the functional additive is the plurality of matting powders. A contact angle of a water droplets on the hot pressing membrane according to the second preferred embodiment of the invention ranges from 80 degrees to 115 degrees.

In one embodiment, the first solvent cam be a first dimethylacetamide (DMAC), a first butyl acetate (BAC), a first ethylene glycol monoethyl ether acetate (CAC), or a mixture therebetween.

In one embodiment, the second solvent can be a second dimethylacetamide (DMAC), a second butyl acetate (BAC), a second ethylene glycol monoethyl ether acetate (CAC), or a mixture therebetween.

In one embodiment, during the hot pressing process, the hot pressing membrane according to the second preferred embodiment of the invention is also bonded to a second outer surface of a second object via the decorative layer to link the first object and the second object. A gap exists between the first object and the second object. The second outer surface of the second object is pressed downward against the first object with a peak force in a first range of 50 g to 70 g and a click ratio in a second range of 35% to 55%.

Different from the prior art, the hot pressing membrane according to the invention has the advantages of well abrasion resistance, high hydrophobicity, good tactile, etc. When the hot pressing membrane according to the invention is in bonded by a hot pressing process to an object such as a switch, a keyboard, and other devices or members of an apparatus that requires press operation, the hot pressing membrane according to the invention also has excellent pressing properties.

The advantage and spirit of the invention may be understood by the following recitations together with the appended drawings.

### BRIEF DESCRIPTION OF THE APPENDED DRAWINGS

FIG. 1 is a partial cross-sectional view of the hot pressing membrane according to the first preferred embodiment of the invention.

FIG. 2 is a partial cross-sectional view of the hot pressing membrane according to the first preferred embodiment of the invention and a first object and a second object to which the hot pressing membrane according to the first preferred embodiment of the invention is bonded.

FIG. 3 is a partial cross-sectional view of the hot pressing membrane according to the second preferred embodiment of the invention.

FIG. 4 is a partial cross-sectional view of the hot pressing membrane according to the second preferred embodiment of the invention and a first object and a second object to which the hot pressing membrane according to the second preferred embodiment of the invention is bonded.

### DETAILED DESCRIPTION OF THE INVENTION

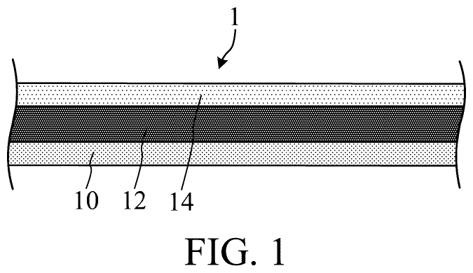

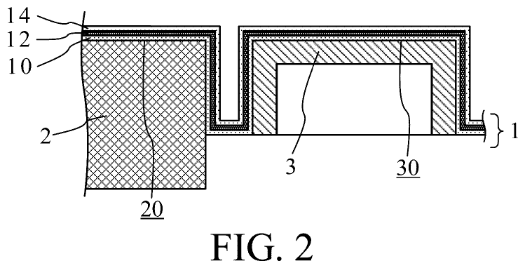

Referring to FIG. 1 and FIG. 2, FIG. 1 schematically illustrates with a partial cross-sectional view the hot pressing membrane 1 according to the first preferred embodiment of the invention. FIG. 2 schematically illustrates with a partial cross-sectional view the hot pressing membrane 1 according to the first preferred embodiment of the invention and the first object 2 and the second object 3 to which the hot pressing membrane 1 according to the first preferred embodiment of the invention is bonded.

As shown in FIG. 2, the hot pressing membrane 1 according to the first preferred embodiment of the invention is used to decorate a first outer surface 20 of the first object 2. As shown in FIG. 1, the hot pressing membrane 1 according to the first preferred embodiment of the invention includes a carrier film 10, a decorative layer 12 and a transparent protective layer 14.

The carrier film 10 can be formed of a polypropylene (PP), a polyethylene (PE), a polyethylene terephthalate (PET), a polycarbonate (PC) or the like. A first thickness of the carrier film 10 ranges from 0.12 mm to 0.18 mm.

The decorative layer 12 is formed on the carrier film 10. The decorative layer 12 includes, in parts by weight, 4.0 to 6.0 parts by weight of a first thermoplastic polyurethane (TPU), 1.0 to 2.0 parts by weight of a pigment, and 12.0 to 15.0 parts by weight of a first solvent. The first thermoplastic polyurethane, the pigment and the first solvent are mixed, coated on the carrier film 10, and baked and dried at a first baking temperature to form the decorative layer 12. The first baking temperature ranges from 50° C. to 100° C. A second thickness of the decorative layer 12 ranges from 40 μm to 50 μm.

The transparent protective layer 14 is formed on the decorative layer 12. The transparent protective layer 14 includes, in parts by weight, 4.0 to 6.0 parts by weight of a second thermoplastic polyurethane (TPU), 0.6 to 2.0 parts by weight of a functional additive, and 11.0 to 14.0 parts by weight of a second solvent. The functional additive can include a plurality of matting powders, an antimicrobial agent, an antistatic agent, and so on. The second thermoplastic polyurethane, the functional additive and the second solvent are mixed, coated on the decorative layer 12, and baked and dried at a second baking temperature to form the transparent protective layer 14. The second baking temperature ranges from 50° C. to 100° C. A third thickness of the transparent protective layer 14 ranges from 50 μm to 60 μm. The first thermoplastic polyurethane forming the decorative layer 12 and the second thermoplastic polyurethane forming the transparent protective layer 14 are polymer elastomers which are environmentally friendly materials, do not contain plasticizers, and are not toxic to users.

In one embodiment, the surface of the carrier film 10 can be matte, i.e., the surface of the carrier film 10 is a rough surface with a leathery texture, such that the appearances of the decorative layer 12 and the transparent protective layer 14 thereon also have a leathery texture.

As shown in FIG. 2, the hot pressing membrane 1 according to the first preferred embodiment of the invention is via the carrier film 10 bonded to the first outer surface 20 of the first object 2 by a hot pressing process. A mold temperature of the hot pressing process ranges from 80° C. to 130° C. A scratch resistance test is conducted for the hot pressing membrane 1 according to the first preferred embodiment of the invention with a tungsten carbide hemispherical needle tip of 1 mm in diameter and under a test load of 200 gf in accordance with the ASTM D3363 test standard. A scratch resistance of the hot pressing membrane 1 according to the first preferred embodiment of the invention is equal to or greater than 50 times. The Shore hardness of the hot pressing membrane 1 according to the first preferred embodiment of the invention ranges from 70 A to 75 A. Obviously, the hot pressing membrane 1 according to the first preferred embodiment of the invention is abrasion-resistant and has high hardness.

In one embodiment, the first solvent cam be a first dimethylacetamide (DMAC), a first butyl acetate (BAC), a first ethylene glycol monoethyl ether acetate (CAC), or a mixture therebetween.

In one embodiment, the second solvent can be a second dimethylacetamide (DMAC), a second butyl acetate (BAC), a second ethylene glycol monoethyl ether acetate (CAC), or a mixture therebetween.

In one embodiment, the functional additive is the plurality of matting powders. A contact angle of a water droplets on the hot pressing membrane 1 according to the first preferred embodiment of the invention ranges from 80 degrees to 115 degrees. Thereby, the hot press film 1 according to the first preferred embodiment of the invention has high hydrophobicity and good tactile.

In one embodiment, also as shown in FIG. 2, during the hot pressing process, the hot pressing membrane 1 according to the first preferred embodiment of the invention is also bonded to a second outer surface 30 of a second object 3 via the carrier film 10 to link the first object 2 and the second object 3. A gap exists between the first object 2 and the second object 3. In practical application, the first object 2 and the second object 3 can be switches, keyboards, and other devices or members of an apparatus that require pressing operation, but the invention is not limited thereto. The hot pressing membrane 1 according to the first preferred embodiment of the invention also seals the gaps between the devices and members of the switch, keyboard, and other apparatus that needs to be operated by pressing, so that the switch, keyboard, and other apparatus that needs to be operated by pressing have a waterproof function.

By using the heat pressing membrane 1 according to the first preferred embodiment of the invention, the first object 2 is linked to the second object 3, and the second outer surface 30 of the second object 3 is pressed downwardly against the first object 2.

When a key of a switch, a keyboard, or other apparatus that needs to be pressed begins to fall under force and the force-stroke curve is recorded, the greater the force, the greater the downward stroke, and the more the key will fall. When the peak of the force-stroke curve is reached, the force applied at this point is called the peak force (F₁), which is the maximum force that can be withstood by the beveled wall of the key. After passing the apex of the force-stroke curve, the force that the key can withstand suddenly drops down sharply. This is due to the fact that the beveled wall of the key begins to bend and cannot withstand the force of the pressing, which causes the key to drop down sharply until it touches the base plate, and the force that is applied at this point is known as the contact force (F₂). The designed values of the peak force (F₁) are usually different for different apparatuses that require pressing operation. For example, the peak force (F₁) of a small calculator is only about 30˜80 g, while the peak force (F₁) of a typical telephone button is between 70˜200 g and the peak force (F₁) of a computer keyboard is between 40˜90 g.

How well a key feels when pressed also depends on the amount of contact force (F₂). However, in general, the design of switches, keyboards, and other apparatuses that require pressing operation does not directly define the contact force (F₂), but rather the ratio of the peak force (F₁) to the contact force (F₂), i.e., the click ratio (CR), which is defined as follows:

$$CR = \frac{{F}_{1} - {F}_{2}}{{F}_{1}} \times 100 \%$$

Usually, the click ratio (CR) is between 40% and 65%.

After actual testing, the second outer surface 30 of the second object 3 is pressed downward against the first object 2 with a peak force (F₁) in a first range of 50 g to 70 g and a click ratio (CR) in a second range of 35% to 55%. Obviously, when the hot pressing membrane 1 according to the first preferred embodiment of the invention is by the hot pressing process linked to an object such as a device or a member of an apparatus to be operated by pressing, such as a switch or a keyboard, etc., the hot pressing membrane 1 according to the first preferred embodiment of the invention has an excellent property with respect to pressing.

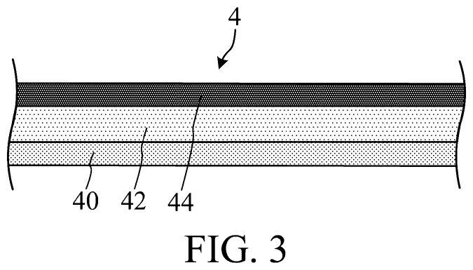

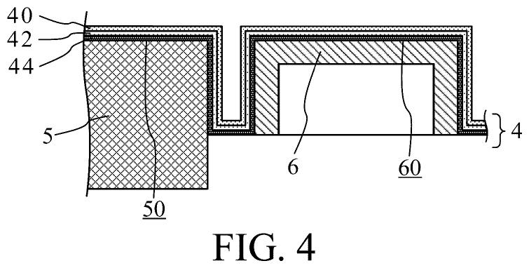

Referring to FIG. 3 and FIG. 4, FIG. 3 schematically illustrates with a partial cross-sectional view the hot pressing membrane 4 according to the second preferred embodiment of the invention. FIG. 4 schematically illustrates with a partial cross-sectional view the hot pressing membrane 4 according to the second preferred embodiment of the invention and the first object 5 and the second object 6 to which the hot pressing membrane 4 according to the second preferred embodiment of the invention is bonded.

As shown in FIG. 4, the hot pressing membrane 4 according to the second preferred embodiment of the invention is used to decorate a first outer surface 50 of the first object 5. As shown in FIG. 3, the hot pressing membrane 4 according to the second preferred embodiment of the transparent protective layer invention includes a carrier film 40, a transparent protective layer 42 and a decorative layer 44.

The carrier film 40 can be formed of a polypropylene (PP), a polyethylene (PE), a polyethylene terephthalate (PET), a polycarbonate (PC), or the like. A first thickness of the carrier film 40 ranging from 0.12 mm to 0.18 mm.

The transparent protective layer 42 is formed on the carrier film 40. The transparent protective layer 42 includes, in parts by weight, 4.0 to 6.0 parts by weight of a first thermoplastic polyurethane, 0.6 to 2.0 parts by weight of a functional additive, and 11.0 to 14.0 parts by weight of a first solvent. The functional additive can include a plurality of matting powders, an antimicrobial agent, an antistatic agent, and so on. The first thermoplastic polyurethane, the functional additive and the first solvent are mixed, coated on the carrier film 40, and baked and dried at a first baking temperature to form the transparent protective layer 42. The first baking temperature ranges from 50° C. to 100° C. A second thickness of the transparent protective layer 42 ranges from 50 μm to 60 μm.

The decorative layer 44 is formed on the transparent protective layer 42. The decorative layer 44 includes, in parts by weight, 4.0 to 6.0 parts by weight of a second thermoplastic polyurethane (TPU), 1.0 to 2.0 parts by weight of a pigment, and 12.0 to 15.0 parts by weight of a second solvent. The second thermoplastic polyurethane, the pigment and the second solvent are mixed, coated on the transparent protective layer 42, and baked and dried at a second baking temperature to form the decorative layer 44. The second baking temperature ranges from 50° C. to 100° C. A third thickness of the decorative layer 44 ranges from 40 μm to 50 μm. The first thermoplastic polyurethane forming the transparent protective layer 42 and the second thermoplastic polyurethane forming the decorative layer 44 are polymer elastomers which are environmentally friendly materials, do not contain plasticizers, and are not toxic to users.

In one embodiment, the surface of the carrier film 40 can be matte, i.e., the surface of the carrier film 40 is a rough surface with a leathery texture, such that the appearance of the hot pressing membrane 4 according to the second preferred embodiment of the invention also has a leathery texture.

As shown in FIG. 4, the hot pressing membrane 4 according to the second preferred embodiment of the invention is via the decorative layer 44 bonded to the first outer surface 50 of the first object 5 by a hot pressing process. A mold temperature of the hot pressing process ranges from 80° C. to 130° C. A scratch resistance test is conducted for the hot pressing membrane 4 according to the second preferred embodiment of the invention with a tungsten carbide hemispherical needle tip of 1 mm in diameter and under a test load of 200 gf in accordance with the ASTM D3363 test standard. A scratch resistance of the hot pressing membrane 4 according to the second preferred embodiment of the invention is equal to or greater than 50 times. The Shore hardness of the hot pressing membrane 4 according to the second preferred embodiment of the invention ranges from 70 A to 75 A. Obviously, the hot pressing membrane 1 according to the second preferred embodiment of the invention is abrasion-resistant and has high hardness.

In one embodiment, the first solvent cam be a first dimethylacetamide (DMAC), a first butyl acetate (BAC), a first ethylene glycol monoethyl ether acetate (CAC), or a mixture therebetween.

In one embodiment, the second solvent can be a second dimethylacetamide (DMAC), a second butyl acetate (BAC), a second ethylene glycol monoethyl ether acetate (CAC), or a mixture therebetween.

In one embodiment, the functional additive is the plurality of matting powders. A contact angle of a water droplets on the hot pressing membrane 4 according to the second preferred embodiment of the invention ranges from 80 degrees to 115 degrees.

In one embodiment, also as shown in FIG. 4, during the hot pressing process, the hot pressing membrane 4 according to the second preferred embodiment of the invention is also bonded to a second outer surface 60 of a second object via the decorative layer 44 to link the first object 5 and the second object. A gap exists between the first object 5 and the second object. In practical application, the first object 5 and the second object 6 can be switches, keyboards, and other devices or members of an apparatus that require pressing operation, but the invention is not limited thereto. The hot pressing membrane 4 according to the second preferred embodiment of the invention also seals the gaps between the devices and members of the switch, keyboard, and other apparatus that needs to be operated by pressing, so that the switch, keyboard, and other apparatus that needs to be operated by pressing have a waterproof function.

By using the heat pressing membrane 4 according to the second preferred embodiment of the invention, the first object 5 is linked to the second object 6, and the second outer surface 60 of the second object 6 is pressed downwardly against the first object 5. After actual testing, the second outer surface 60 of the second object 6 is pressed downward against the first object 5 with a peak force in a first range of 50 g to 70 g and a click ratio in a second range of 35% to 55%. Obviously, when the hot pressing membrane 4 according to the second preferred embodiment of the invention is by the hot pressing process linked to an object such as a device or a member of an apparatus to be operated by pressing, such as a switch or a keyboard, etc., the hot pressing membrane 4 according to the second preferred embodiment of the invention has an excellent property with respect to pressing.

With the detailed description of the above preferred embodiments of the invention, it is clear to understand that the hot pressing membrane according to the invention has the advantages of well abrasion resistance, high hydrophobicity, good tactile, etc. When the hot pressing membrane according to the invention is bonded by a hot pressing process to an object such as a switch, a keyboard, and other devices or members of an apparatus that requires press operation, the hot pressing membrane according to the invention also has excellent pressing properties.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A hot pressing membrane for decorating a first outer surface of a first object, said hot pressing membrane comprising:
a carrier film, formed of one selected from the group consisting of a polypropylene (PP), a polyethylene (PE), a polyethylene terephthalate (PET), and a polycarbonate (PC), a first thickness of the carrier film ranging from 0.12 mm to 0.18 mm;
a decorative layer, formed on the carrier film, the decorative layer, in parts by weight, comprising 4.0 to 6.0 parts by weight of a first thermoplastic polyurethane (TPU), 1.0 to 2.0 parts by weight of a pigment, and 12.0 to 15.0 parts by weight of a first solvent, wherein the first thermoplastic polyurethane, the pigment and the first solvent are mixed, coated on the carrier film, and baked and dried at a first baking temperature to form the decorative layer, the first baking temperature ranges from 50° C. to 100° C., a second thickness of the decorative layer ranges from 40 μm to 50 μm; and
a transparent protective layer, formed on the decorative layer, the transparent protective layer, in parts by weight, comprising 4.0 to 6.0 parts by weight of a second thermoplastic polyurethane (TPU), 0.6 to 2.0 parts by weight of a functional additive, and 11.0 to 14.0 parts by weight of a second solvent, the functional additive comprising one selected from the group consisting of a plurality of matting powders, an antimicrobial agent and an antistatic agent, wherein the second thermoplastic polyurethane, the functional additive and the second solvent are mixed, coated on the decorative layer, and baked and dried at a second baking temperature to form the transparent protective layer, the second baking temperature ranges from 50° C. to 100° C., a third thickness of the transparent protective layer ranges from 50 μm to 60 μm;
wherein the hot pressing membrane is via the carrier film bonded to the first outer surface of the first object by a hot pressing process, a mold temperature of the hot pressing process ranges from 80° C. to 130° C., a scratch resistance of the hot pressing membrane is equal to or greater than 50 times, a Shore hardness of the hot pressing membrane ranges from 70 A to 75 A.

2. The hot pressing membrane of claim 1, wherein the functional additive is the plurality of matting powders, a contact angle of a water droplets on the hot pressing membrane ranges from 80 degrees to 115 degrees.

3. The hot pressing membrane of claim 2, wherein the first solvent is one selected from the group consisting of a first dimethylacetamide (DMAC), a first butyl acetate (BAC), a first ethylene glycol monoethyl ether acetate (CAC), and a mixture therebetween.

4. The hot pressing membrane of claim 3, wherein the second solvent is one selected from the group consisting of a second dimethylacetamide (DMAC), a second butyl acetate (BAC), a second ethylene glycol monoethyl ether acetate (CAC), and a mixture therebetween.

5. The hot pressing membrane of claim 4, wherein during the hot pressing process, the hot pressing membrane is also bonded to a second outer surface of a second object via the carrier film to link the first object and the second object, a gap exists between the first object and the second object, and the second outer surface of the second object is pressed downward against the first object with a peak force in a first range of 50 g to 70 g and a click ratio in a second range of 35% to 55%.

6. A hot pressing membrane for decorating a first outer surface of a first object, said hot pressing membrane comprising:
a carrier film, formed of one selected from the group consisting of a polypropylene (PP), a polyethylene (PE), a polyethylene terephthalate (PET), and a polycarbonate (PC), a first thickness of the carrier film ranging from 0.12 mm to 0.18 mm;
a transparent protective layer, formed on the carrier film, the transparent protective layer, in parts by weight, comprising 4.0 to 6.0 parts by weight of a first thermoplastic polyurethane, 0.6 to 2.0 parts by weight of a functional additive, and 11.0 to 14.0 parts by weight of a first solvent, the functional additive comprising one selected from the group consisting of a plurality of matting powders, an antimicrobial agent and an antistatic agent, wherein the first thermoplastic polyurethane, the functional additive and the first solvent are mixed, coated on the carrier film, and baked and dried at a first baking temperature to form the transparent protective layer, the first baking temperature ranges from 50° C. to 100° C., a second thickness of the transparent protective layer ranges from 50 μm to 60 μm; and
a decorative layer, formed on the transparent protective layer, the decorative layer, in parts by weight, comprising 4.0 to 6.0 parts by weight of a second thermoplastic polyurethane (TPU), 1.0 to 2.0 parts by weight of a pigment, and 12.0 to 15.0 parts by weight of a second solvent, wherein the second thermoplastic polyurethane, the pigment and the second solvent are mixed, coated on the transparent protective layer, and baked and dried at a second baking temperature to form the decorative layer, the second baking temperature ranges from 50° C. to 100° C., a third thickness of the decorative layer ranges from 40 μm to 50 μm;
wherein the hot pressing membrane is via the decorative layer bonded to the first outer surface of the first object by a hot pressing process, a mold temperature of the hot pressing process ranges from 80° C. to 130° C., a scratch resistance of the hot pressing membrane is equal to or greater than 50 times, a Shore hardness of the hot pressing membrane ranges from 70 A to 75 A.

7. The hot pressing membrane of claim 6, wherein the functional additive is the plurality of matting powders, a contact angle of a water droplets on the hot pressing membrane ranges from 80 degrees to 115 degrees.

8. The hot pressing membrane of claim 7, wherein the first solvent is one selected from the group consisting of a first dimethylacetamide (DMAC), a first butyl acetate (BAC), a first ethylene glycol monoethyl ether acetate (CAC), a mixture therebetween.

9. The hot pressing membrane of claim 8, wherein the second solvent is one selected from the group consisting of a second dimethylacetamide (DMAC), a second butyl acetate (BAC), a second ethylene glycol monoethyl ether acetate (CAC), a mixture therebetween.

10. The hot pressing membrane of claim 9, wherein during the hot pressing process, the hot pressing membrane is also bonded to a second outer surface of a second object via the decorative layer to link the first object and the second object, a gap exists between the first object and the second object, and the second outer surface of the second object is pressed downward against the first object with a peak force in a first range of 50 g to 70 g and a click ratio in a second range of 35% to 55%.
